(19) United States
(12) Patent Application Publication
(10) Pub. No.: US 2016/0238574 A1
(43) Pub. Date: Aug. 18, 2016

(54) Sensor for Measuring a Property of an Aggressive Liquid

(71) Applicant: CONTINENTAL AUTOMOTIVE GMBH, Hannover (DE)

(72) Inventor: Willibald Reitmeier, Hohenschambach (DE)

(73) Assignee: Continental Automotive GmbH, Hannover (DE)

(21) Appl. No.: 15/029,774

(22) PCT Filed: Oct. 14, 2014
(86) PCT No.: PCT/EP2014/072054

§ 371 Date: Apr. 15, 2016

(30) Foreign Application Priority Data
Oct. 15, 2013 (DE) 10 2013 220 916.9

(51) Int. Cl. G01N 30/64; G01N 27/22; G01N 27/07

(52) U.S. Cl. CPC G01N 30/64; G01N 27/07; G01N 27/22

(57) ABSTRACT

The present disclosure relates to a sensor for measuring a property of an aggressive liquid. The sensor may include a tube with a tube wall and a measuring device at least partially extending through the tube wall. The tube may be made of a chemically resistant polymer. The part of the measuring device extending through the tube wall may include an electrode guided through the tube wall and with an open electrode structure on and in the tube wall.

### CROSS-REFERENCE TO RELATED APPLICATIONS

This application is a U.S. National Stage Application of International Application No. PCT/EP2014/072054 filed Oct. 14, 2014, which designates the United States of America, and claims priority to DE Application No. 10 2013 220 916.9 filed Oct. 15, 2013, the contents of which are hereby incorporated by reference in their entirety.

### TECHNICAL FIELD

The present invention relates to sensors in general and, more specifically, to sensors for measuring a property of an aggressive liquid.

### BACKGROUND

Sensors for measuring a property of an aggressive liquid are known. A commercially available sensor has a metal tube with a window soldered into it or with a glazed capacitive electrode structure. Such a metal tube protects the corresponding sensor parts in relation to the aggressive liquid which is to be measured, but is accompanied by certain disadvantages, such as high costs, high production outlay, a high coefficient of expansion, etc.

A sensor is known from EP 0 335 268 B1. This example sensor is a detector cell for liquid chromatography, in the case of which the at least one part which extends through the wall of the tube provided is an optical lens.

WO 2011/044474 A1 discloses chromatography components, i.e. likewise an optical sensor unit. Here too, a tube provided consists, at least in part, of a chemically resistant polymer.

Further optical sensors are described in JP 20000146826 (A) and DE 35 39 248 A1.

### SUMMARY

The teachings of the present disclosure relate to sensors for aggressive liquids which, while being of straightforward configuration, are distinguished by a particularly high level of robustness.

Using chemically resistant polymers for forming the sensor tube makes it possible to dispense with metal tubes. The tube produced, at least in part, from the chemically resistant polymer has a high level of robustness in relation to the aggressive liquid which is to be measured, can also be produced straightforwardly and is cost-effective. It usually has a low coefficient of thermal expansion in comparison with metal, and also has a high level of chemical resistance and high temperature resistance. The material can be processed to good effect and can be made into the desired shape without any high-outlay production methods being required. It has a high level of adhesion in relation to materials such as, for example, metals and can therefore also be processed in conjunction therewith. The modulus of elasticity is correspondingly large.

It is also possible, in the case of such polymers, to realize admixtures or blends of which the properties can be altered straightforwardly, and therefore adaptation to the respective use purpose can readily take place.

In some embodiments, the tube consists, at least in part, of a chemically resistant polymer based on epoxy resin. The advantages and properties indicated above can be achieved in particular using such a polymer.

That part of the measuring device which extends through the tube wall is an electrode, which is guided through the tube wall. It is possible here to arrange, for example within the tube, a measuring tube, from which a corresponding electrode extends through the tube wall. The measuring tube here may be freely suspended in the tube, but may also be mounted on supports within the tube. The embodiment according to the invention, in which electrode material extends through the tube wall, gives rise to advantages in so far as it is possible to have open electrode structures on and in the tube wall. The electrical contact material can be connected straightforwardly to, for example, sensor elements, heating means, etc. It is also possible for additional mechanical supporting elements or, for example, also flow-forming elements (laminating routes) to be arranged in the tube. Such a sensor is suitable, in particular, for capacitive measurement.

As far as the production of the tube is concerned, the latter may be produced in one piece, but may also be made from two or more half-shells which are welded or adhesively bonded to one another. Of course, other production options are also conceivable.

It is also possible to have any desired apertures or cutouts in the tube.

At least partially replacing a metallic solution of the tube (measuring tube) by a polymer solution thus readily makes it possible to realize combinations of a tube or measuring tube with an electrode bushing through the tube wall. The tube consisting, at least in part, of the chemically resistant polymer can have any desired functional geometry, for example SAE standard connections. It is straightforwardly possible to incorporate sealing surfaces or mechanical contact locations, for example screw-connection locations, press-fit attachment means, etc. The same applies to the use of lead frames as contact electrodes.

In some embodiments, the tube or measuring tube can be combined with open, large-surface-area electrodes or also multiple electrodes (at various measuring locations). The tube also makes it possible for additional forming elements to be introduced straightforwardly, for example in order to form a laminar flow.

In some embodiments, the tube is a combination of a metal tube and a polymer tube. It is possible here for the tube to be, in particular, a metal tube in which a joint location made of a chemically resistant polymer is integrated. Such a joint location may be introduced into the tube, for example, by injection molding. Such a joint location may be, for example, an electrode.

The tube may also comprise a means for the inductive coupling of the signals/energy in/out through the tube wall. The electrode material may be applied flush or in coating form on the tube wall. It is also possible for a line-routing means/lead frame to be arranged in the tube wall.

One or more active and/or passive elements/bodies may be arranged in the tube, it being possible for the tube to contain, in particular, a flow-forming element.

### BRIEF DESCRIPTION OF THE DRAWINGS

The invention will be explained in detail herein below by way of exemplary embodiments in conjunction with the drawing, in which:

FIG. 1 shows a schematic illustration of a sensor provided with a tube made of a chemically resistant polymer; and

FIG. 2 shows a corresponding illustration of a different embodiment of a sensor.

### DETAILED DESCRIPTION

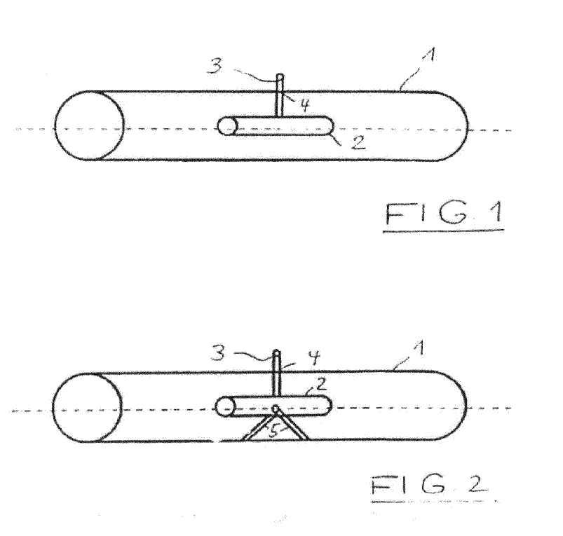

FIG. 1 shows a schematic illustration of a first embodiment of a sensor for measuring a property of an aggressive liquid, for example for measuring the quality of the liquid. The sensor has a tube 1 and a measuring device, of which at least part extends through the tube wall. The measuring device here is a measuring tube 2 with an electrode connection 3. The corresponding electrode extends here through the wall of the tube 1, as shown at 4.

The tube 1, in this embodiment, consists of a polymer based on epoxy resin. By means of such a material, the electrode can readily be guided in a sealed manner through the tube wall.

That embodiment of a sensor which is shown in FIG. 2 differs from that of FIG. 1 only by the fact that the measuring tube 2, which is arranged in the interior of the tube 1, is mounted on two supports 5, which are fitted on the base of the tube 1. The tube 1, which consists of the epoxy-resin material, is thus also very well-suited for parts of the measuring device to be arranged within the tube.

What is claimed is:

1. A sensor for measuring a property of an aggressive liquid, the sensor comprising:
a tube with a tube wall, and
a measuring device at least partially extending through the tube wall,
wherein the tube comprises a chemically resistant polymer, and
the part of the measuring device extending through the tube wall comprises an electrode guided through the tube wall and with an open electrode structure on and in the tube wall.

2. The sensor as claimed in claim 1, further comprising a measuring tube within the tube from which the electrode extends through the tube wall.

3. The sensor as claimed in claim 2, further comprising the measuring tube arranged on supports within the tube.

4. The sensor as claimed in claim 1, wherein the tube comprises a chemically resistant polymer based on epoxy resin.

5. The sensor as claimed claim 1, wherein the tube is produced in one piece.

6. The sensor as claimed in claim 1, wherein the tube is produced from two or more half-shells welded or adhesively bonded to one another.

7. The sensor as claimed in claim 1, wherein the tube is a combination of a metal tube and a polymer tube.

8. The sensor as claimed in claim 7, wherein the tube is a metal tube in which a joint location made of a chemically resistant polymer is integrated.

9. The sensor as claimed in claim 1, wherein the tube comprises a means for the inductive coupling of the signals/energy in/out through the tube wall.

10. The sensor as claimed in claim 1, wherein electrode material is applied flush or in coating form on the tube wall.

11. The sensor as claimed in claim 1, wherein a line-routing means/lead frame is arranged in the tube wall.

12. The sensor as claimed in claim 1, wherein one or more active and/or passive elements/bodies are arranged in the tube.

13. The sensor as claimed in claim 1, wherein the tube contains a flow-forming element.
